(19) United States
(12) Patent Application Publication
(10) Pub. No.: US 2026/0236537 A1
(43) Pub. Date: Aug. 13, 2026

(54) VECTOR SEARCH USING MULTIPLE TYPES OF EMBEDDINGS

(71) Applicant: Salesforce, Inc., San Francisco, CA (US)

(72) Inventors: Sebastian Hofstetter, Munich (DE); Ravi Shanker, Bengaluru (IN); Jan Finis, Bavaria (DE)

(21) Appl. No.: 19/094,001

(22) Filed: Mar. 28, 2025

(30) Foreign Application Priority Data
Feb. 13, 2025 (IN) 202511012421

(51) Int. Cl. G06F 16/9035; G06F 16/901

(52) U.S. Cl. CPC G06F 16/9035; G06F 16/9024

(57) ABSTRACT

Techniques for performing a vector search using binary and/or non-binary quantized embeddings are described herein. A system may receive a request for a machine-learned model to perform an action. The system may generate a non-binary quantized embedding representative of the request. The system may generate a binary quantized embedding of the non-binary quantized embedding. The system may perform a vector search on a database using such data. That is, the system may determine a first subset of rows in the database by identifying a threshold number of the most similar binary quantized embeddings in the database relative to the request binary quantized embedding. The system may determine a second subset of rows by identifying a threshold number of the most similar non-binary quantized embeddings in the first subset of rows relative to the request non-binary quantized embedding and output the data associated with the third subset to a virtual space.

### RELATED APPLICATIONS

This application claims priority to Indian Patent Application No. 202511012421, filed on Feb. 13, 2025, the entire contents of which are incorporated herein by reference

### TECHNICAL FIELD

Companies may use one or more systems and/or platforms to perform various tasks. In some cases, the users may input information to the system and request that the system perform an operation based on such information. However, when requesting that the systems and/or platforms perform an operation based on the information, the operations may result in an undesirable user experience.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates an example system for performing techniques described herein.

FIG. 2 depicts a block diagram illustrating the interactions of components of a data searching component configured to perform a vector search using multiple types of embeddings.

FIG. 3 is an example database illustrating as a table including rows and/or columns that include non-binary quantized embedding(s), binary quantized embedding(s), filter(s), and/or subsets of content item(s).

FIG. 4 is a flow diagram illustrating an example process for receiving a query, determining non-binary quantized embedding based on the query, determining a binary quantized embedding based on the non-binary quantized embedding, determining a subset of rows of a database based on the binary quantized embedding, determining a second subset of rows based on the non-binary quantized embedding and the first subset, and outputting the second subset to a virtual space.

### DETAILED DESCRIPTION

Techniques for performing a vector search using binary and non-binary quantized embeddings are described herein. In some examples, a system may receive a request (or query) for a machine-learned model to perform an action. Based on receiving the request, the system may generate a non-binary quantized embedding (e.g., full length, float-based embedding) representing the request. Further, the system may generate a binary quantized embedding of the non-binary quantized embedding. In some examples, the system may identify one or more filters that are included in the request. Based on such information, the system may perform a vector search operation on a database. For example, the system may determine a first subset of rows in the database that have filters that satisfy the request filter(s). The system may determine a second subset of rows (e.g., subset of the first subset) by identifying a threshold number of the most similar binary quantized embeddings in the first subset of rows relative to the request binary quantized embedding. The system may determine a third subset of rows (e.g., subset of the second subset) by identifying a threshold number of the most similar non-binary quantized embeddings in the second subset of rows relative to the request non-binary quantized embedding. In some examples, the system may output the data associated with the third subset of rows to the requesting virtual space. As discussed throughout this disclosure, the techniques may improve the user experience by decreasing the perceived latency of the model output by increasing the speed and/or accuracy of the vector search performed to satisfy the request.

When performing a vector search, it may be beneficial to consider the speed and/or accuracy of the searching process. That is, performing a vector search on full embedding (e.g., non-binary quantized embedding) can be extremely expensive since the full embeddings continually getting longer. For example, when performing a semantic search (e.g., vector search), the system may generate a database of embeddings from which the system can perform the search. The embeddings may be generated from one or more documents, images, videos, etc. In some cases, the models that are used to generate the embeddings of the documents may generate large embeddings. Further, the models may generate embeddings for large numbers of documents and store such embeddings in a database. However, in some circumstances, when attempting to perform a vector search using a full length query embedding (e.g., non-binary quantized embedding of the query) on the full length database embeddings, the vector search (e.g., comparing the query embedding to each embedding in the database to identify highly similar embedding(s)) may take a long period of time. As such, existing solutions have attempted to use binary quantized embeddings instead of full length embeddings. Binary quantized embeddings may reduce the size and/or dimensionality of the embedding(s) in the database, which may render performing the vector search quicker and less computationally expensive. However, solely using binary quantized embeddings may result in inaccurate results. As such, the techniques and/or solutions described herein include constructing a database including a combination of full length embeddings and quantized embeddings such as to increase the search speed while also increasing accuracy.

To address these and other technical problems and inefficiencies, the systems and/or techniques described herein may include a data searching component (which also may be referred to as a “data searching system”) configured to perform vector searches using a combination of filter(s), binary quantized embedding(s), and/or non-binary quantized embedding(s) (e.g., full length embedding(s)). The technical solutions discussed herein solve one or more technical problems associated with high perceived latency of model output and/or the inaccuracy of the output content.

In some examples, the system may determine to generate a database to be queried. The database may be a relational database (e.g., iceberg database) that includes one or more rows and/or columns. As discussed below, the rows may correspond to chunks of data (e.g., subset(s) of data (e.g., content items)) within a content item (e.g., document, picture, video, etc.) and the columns may correspond to the binary quantized embedding of the chunked data, the full length embedding of the chunked data, and/or one or more filters (e.g., author of the document, recency of the document, organization name, employee data, contributors, etc.).

For example, the system may receive content items to include in the database. A content item may be a document, a picture, a video, audio, a file, and/or any other type of data. In some examples, the content items may be associated with an organization, a company, a platform (e.g., communication platform, sales-based platform, etc.), etc. However, in other examples, the content items may be any type of content item from any type of source.

In some examples, the system may generate chucks of data (e.g., subset(s)) from the content items (e.g., subset(s) of the content item). A chunk of data may be a subset (e.g., less than all, less than an entirety of the content item, etc.) of the document, picture, file, audio, etc. For example, a chunk of data may be a paragraph within a document, one or more sentences within a document or paragraph, a verse in a song, etc. In some examples, the system may generate the chunks of data based on topic (e.g., chunk data such that the data within a chunk corresponds to a same topic), length (or size) of the content (e.g., number of sentences within a threshold limit), etc. Accordingly, the system may determine one or more chunks of data from the content items.

In some examples, the system may generate non-binary quantized embeddings (e.g., full length embedding) of the chunked data. To generate the full length embedding, the system may input the chunks of data into a machine-learned model trained to output a full length embedding. The embedding may be a structured form of representing data, characteristics, and/or features of the chunk of data. The system may generate a separate and/or unique full length embedding for each chunk of data. For example, the system may generate five full length embeddings if the system generated five chunks of data. As noted above, the full length embeddings may include float values.

In some examples, the system may generate binary quantized embeddings (or quantized embeddings) of the full length embeddings. A quantized embedding may be a shortened representation of the full length embedding. The quantized embedding may include binary values (e.g., zero or one) rather than the float values included in the non-binary quantized embeddings. In some examples, the system may use the quantized embeddings since performing a vector search using quantized embeddings may be faster than performing a vector search using full length embeddings due to the quantized embedding being shorter and/or including binary values rather than float values. The system may determine the quantized embedding by determining a threshold and assigning ‘0’ or ‘1’ to the values based on whether the float values of the full length embedding is above or below the threshold. In some examples, the threshold may be a scalar value; however, in other examples, the threshold can be a vector with each dimension of the vector including a threshold value. In some examples, the threshold may be zero. However, in other examples, the system may determine the threshold by inputting a plurality of content items (e.g., content items external to the database (e.g., retrieve external content item(s)) or internal the database (e.g., content items already included in the database)) into the model (e.g., the same or different model used to generate the binary quantized embeddings) and determining a median value of the values within the output embeddings. In this example, the plurality of content items may be similar or relevant (e.g., same language, similar topics, similar authors or artists, etc.) to the content items being included in the database and/or included in a specific row grouping. The distribution of the embedding values may indicate the number to use as the threshold. That is, the system may determine that the median of the distribution may be the threshold, thereby ensuring approximately half of the embedding values may be assigned ‘0’ and half of the embedding values may be ‘1.’

For example, based on determining the threshold, the system may assign, for the new binary quantized embedding, each value of the non-binary quantized embedding that is below the threshold to ‘0’ and each value of the non-binary quantized embedding above the threshold to ‘1.’The result may be the binary quantized embedding based on the full length embedding.

In some examples, the system may also identify filter(s) in the chunked data. Filter data may include recency data (e.g., date of publish, date of updates, date of filing, etc.), authorship data (e.g., the authors or contributors of the documents, pictures, files, etc.), company names, employee data, historical data, and/or any other type of attribute of the content item.

In some examples, the system may generate a database that includes the chunked data, the corresponding quantized embedding(s), the corresponding full length embedding(s), and/or the filter data. As noted above, each row of the database may correspond to a chunk of data such as a paragraph of a document. The columns may correspond to the quantized embedding of the chunk of data, the full length embedding of the chunk of data, and/or the filter data of the chunk of data. Further, in some cases, the database may cluster the one or more rows into a subset. That is, to increase the efficiency of the searching operations, the system may determine subsets based on the quantized embeddings, full length embeddings, and/or the filter data. For example, the system may determine subsets of data based on the authors of the data. As such, a first subset may correspond to authors from “A-G,” the second subset may correspond to authors “H-T,” and the third subset may correspond to authors “U-Z.” That is, the first subset may include one or more rows that include filter data with an author name between “A-G,” the second subset may include one or more rows that include filter data with an author name between “H-T,” and the third subset may include one or more rows that include filter data with an author name between “U-Z.” Accordingly, in this case, if the vector search is to be filtered by an author with the name of “Harry,” the system may forego searching the rows in the first and third subsets since the authors in those subsets (or rows) correspond to different letters. Of course, this example is not intended to be limiting; in other examples, the system may determine more or fewer subsets of data, the subsets may correspond to different filter data (e.g., different attributes of the content items), embeddings, etc.

In some examples, the system may store the database in a platform such as a group-based communication platform, a chat-based platform, a sales-based platform, etc. The platform(s) and/or system(s) may leverage the database to provide results to one or more received queries.

For example, the system may receive a query from a user profile. A query may be a question, comment, request, etc. That is, a user profile may submit a request (or query) to the system for the system to perform an action. The user profile may submit the request by verbally commanding (e.g., speaking—audio data) the system to perform an action, interacting with a user device that uses the system (e.g., clicking or touching a user interface object within the system, typing and/or submitting text to a text entry box within the system, etc.), etc. In some examples, the request may include an instruction for the system to perform an action. The actions may include summarizing data, synthesizing data, generating documents, responding to question(s) and/or prompt(s), receiving data, etc.

In some examples, the system may generate a full length embedding (e.g., non-binary quantized embedding) of the query. That is, the system may include one or more machine-learned models trained to generate full length embeddings of queries. In this example, the system may generate the full length query embedding by inputting the query into a machine-learned model which may output a full length query embedding. The full length query embedding may be a similar type of full length embedding to the full length embeddings described above. For instance, the query full length embedding may include large numbers of values which may be float values.

In some examples, the system may generate a binary quantized embedding of the full length query embedding. That is, the system may generate a binary quantized query embedding such that the system may be able to perform vector searches on the database described above on the quantized embeddings stored therein. In some examples, the system may generate the quantized query embedding by performing similar or identical operations as those described above. For instance, the system may determine a threshold and use the threshold to determine binary values based on the float values of the full length query vector.

In some examples, the system may determine (or identify) one or more filters included in the query. As indicated above, the filter may be narrow the search and/or requested content desired by the requesting user. For example, the query may be “what is the most popular book written by John Smith?” In this example, the filter may be “John Smith,” since the requesting user is requesting results solely focused on “John Smith” and not other authors. Other filters the requesting user may include can include a time frame from which to search, other co-authors, etc.

As described below, the system may perform a vector search using the query filter data, the query quantized embedding, and/or the full length query embedding. That is, the system may access the database to perform the search.

For example, the system may determine a first subset of rows of the database based on the query filter data. That is, the system may use the query filter data to reduce the number of rows that the system is to consider when performing the embedding comparisons. For example, the system may compare the query filter data to the database filter data and identify rows (or chunks of data) that satisfy the query filter data. In some cases, the system may analyze the filter data of each row within the database. However, in other examples, the system may initially consider the groups of rows determined when generating the database. For example, if the filter data is “John Smith,” the system may identify the subset of rows that includes authors with the first letter of “J” and then perform the filter data comparison only on the rows within the subset. Such a technique may reduce the number of rows that the system is to consider when performing the filter data comparison. Importantly, the first subset of rows may be less than all of the rows in the database.

In some examples, the system may determine a second subset of rows by comparing the query quantized embedding to the database quantized embeddings (e.g., distance comparison) in the first subset (e.g., the filtered subset). That is, the system may perform a comparison operation to identify, from the rows in the first subset, which database quantized embeddings are most similar to the query quantized embedding. In such examples, the system may compare the values of the query quantized embedding with the values of the database quantized embedding. The system may determine similarity scores that indicate the level to which a specific database quantized vector matches the query quantized vector. In some cases, the system may perform such a similarity comparison using one or more heuristics and/or one or more machine-learned models. Based on determining the similarity scores, the system may determine the second subset by including the rows with the database quantized embeddings that meet or exceed a threshold. The threshold may be used to filter out the rows with database quantized vectors with lower similarity scores. For example, the threshold may be 90, which may indicate that the second subset includes the 90 rows that have quantized vectors with the highest similarity scores.

In some examples, the system may determine a third subset of rows by comparing the query full length embedding to the database full length embeddings in the second subset. That is, the system may perform a comparison, from the rows included in the second subset (e.g., most similar quantized embeddings), operation to identify which database full length embeddings are most similar to the query full length embedding. In such examples, the system may compare the values of the query full length embedding with the values of the database full length embedding. The system may determine similarity scores that indicate the level to which a specific database full length vector matches the query full length vector. In some cases, the system may perform such a similarity comparison using one or more heuristics and/or one or more machine-learned models. Based on determining the similarity scores, the system may determine the third subset of rows by including the rows with the full length database embeddings that meet or exceed a threshold. The threshold may be used to filter out the rows with full length database vectors with lower similarity scores. For example, the threshold may be 5 or 10, which may indicate that the third subset includes the 5 or 10 rows that have full length vectors with the highest similarity scores. In some examples, the threshold for the full length vector comparison may be less than the threshold for the quantized vector comparison.

In some examples, the system may cause the data associated with the third subset of rows to be displayed to the requesting user. That is, the system may perform any requested action (e.g., summarized data, synthesize data, etc.) on the chunks of data included in the third subset and output the response. The system may output the output data via displaying the output data on a user interface of a user device and/or causing a device to emit the output data via audio. That is, if the user requested the action via a user interface of a user device, the system may cause the output data to be displayed via the user interface. Further, if the user requested the action via speaking to a device, the system may cause the output to be emitted via audio. However, this is not intended to be limiting; in other examples, the system may emit the output via audio in response to the user requesting the action via a user interface and/or the system may cause the output data to be displayed via user interface in response to the user verbally requesting the action.

As illustrated by these examples, the techniques described herein can improve the functioning, efficiency, and overall user experience of the communication platform. That is, the techniques described herein may enable the system to reduce the number of rows with which to compare against the request embedding. That is, utilizing the binary quantized embeddings may increase the speed at which the comparison procedure is performed and may define a subset of the rows on which the full length embedding comparison is to be performed on.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The following detailed description of examples references the accompanying drawings that illustrate specific examples in which the techniques can be practiced. The examples are intended to describe aspects of the systems and methods in sufficient detail to enable those skilled in the art to practice the techniques discussed herein. Other examples can be utilized and changes can be made without departing from the scope of the disclosure. The following detailed description is, therefore, not to be taken in a limiting sense. The scope of the disclosure is defined only by the appended claims, along with the full scope of equivalents to which such claims are entitled.

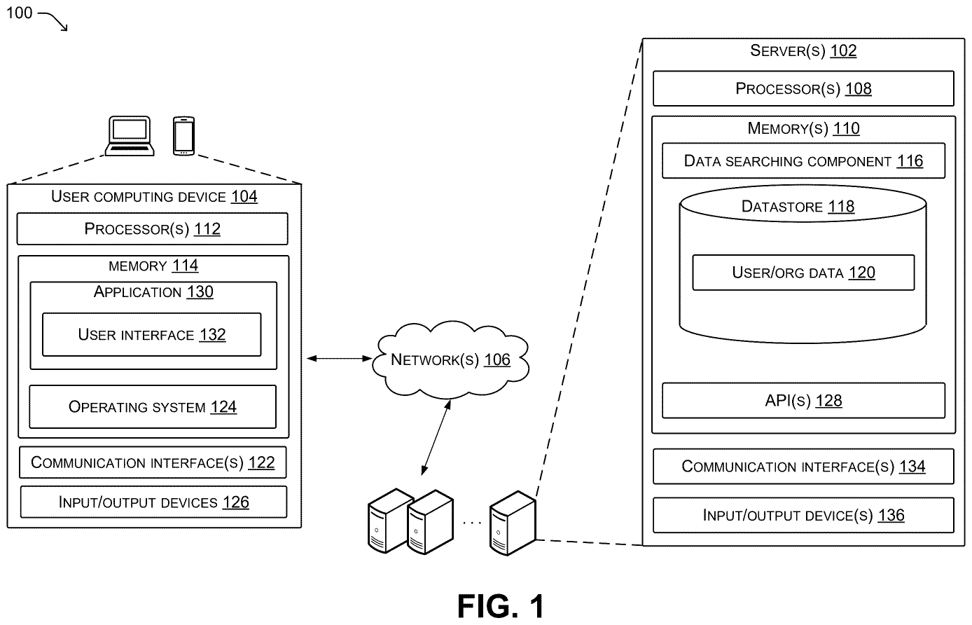

FIG. 1 illustrates an example environment 100 for performing the techniques described herein. The techniques discussed herein may be used in a variety of environments and for a variety of uses, although the examples given herein discuss a customer service environment as one of these use cases since it's a use case familiar to many. In additional or alternate examples, the computing environment may comprise computing devices used for sales-based systems, communication platforms, chat engines, cybersecurity, search engines, multi-agent/agentic machine-learned model pipeline(s) and/or cluster(s), machine-learned model training, cloud/distributed computing or massive computing efficient data storage and/or retrieval, and/or the like.

In at least one example, the example environment 100 can include one or more computing devices, such as server(s) 102 and/or a user computing device(s) 104. By way of example and not limitation, the server(s) 102 may be representative of servers for hosting the software, hardware, containers, and/or the like to implement at least part of the techniques discussed herein. For example, the server(s) 102 may host (e.g., store and/or execute) system software. The user computing device(s) 104 may be representative of user computing device(s) associated with a first user (i.e., a first “client device”).

The server(s) 102 may comprise one or more individual servers or other computing devices that may be physically located in a single central location or may be distributed at multiple different locations. The server(s) 102 communication may be hosted privately by an entity administering all or part of the environment 100 (e.g., a utility company, a governmental body, distributor, a retailer, manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures can additionally or alternatively be used. Moreover, the server(s) 102 may comprise hardware and/or software containers accessible to different tenants with access to the server(s) 102.

The user computing device(s) 104 may be any suitable type of computing device, e.g., portable, semi-portable, semi-stationary, or stationary. Some examples of the user computing device(s) 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. In some examples, the user computing device(s) 104 may comprise distributed computing devices, server(s), etc.

In some examples, the server(s) 102 and/or user computing device(s) 104 may be configured to transmit network packages therebetween via network(s) 106. The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network,, or any other such network, or any combination thereof. The network(s) 106 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the user computing device(s) 104 may transmit a request to and/receive an output from the server(s) 102 via the communication platform. Components used for such communications can depend at least in part upon the type of network, the environment selected, or both. Further, the network(s) 106 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON objects sent via a Websocket channel. In some embodiments, the protocol is JSON over RPC, JSON over REST/HTTP, and the like.

The server(s) 102 and the user computing device(s) 104 described herein may include one or more processors and/or memory. Specifically, in the illustrated example, server(s) 102 may include processor(s) 108 and memory 110 and user computing device(s) 104 include processor(s) 112 and memory 114.

By way of example and not limitation, the processor(s) 108 and/or 112 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions. For example, the processor(s) 108 and/or 112 can be one or more hardware processors and/or logic circuits of any suitable type specifically programmed or configured to execute the algorithms and processes described herein. The processor(s) 108 and/or 112 can be configured to fetch and execute computer-readable instructions stored in the computer-readable media, which can program the processor(s) to perform the functions described herein.

The memory 110 and/or 114 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 110 and/or 114 can be used to store any number of software/functional components that are executable by the processor(s) 108 and/or 112, respectively. In many implementations, these functional components comprise instructions or programs that are executable by the processor(s) 108 and/or 112 and that, when executed, specifically configure the processor(s) 108 and/or 112 to perform the actions server(s) 102 and/or user computing device(s) 104, according to the discussion herein.

For example, server(s) 102 may comprise a memory 110 storing the data searching component 116. In some examples, a data searching component 116 may receive a request (or query) for a machine-learned model to perform an action. Based on receiving the request, the data searching component 116 may generate a non-binary quantized embedding (e.g., full length, float-based embedding) representing the request. The data searching component 116 may generate a binary quantized embedding of the non-binary quantized embedding. In some examples, the data searching component 116 may identify one or more filters that are included in the request. Based on such information, the data searching component 116 may perform a vector search operation on a database. For example, the data searching component 116 may determine a first subset of rows in the database that have filters that satisfy the request filter(s). The data searching component 116 may determine a second subset of rows (e.g., subset of the first subset) by identifying a threshold number of the most similar binary quantized embeddings in the first subset of rows to the request binary quantized embedding. The data searching component 116 may determine a third subset of rows (e.g., subset of the second subset) by identifying a threshold number of the most similar non-binary quantized embeddings in the second subset of rows to the request non-binary quantized embedding. In some examples, the data searching component 116 may output the data associated with the third subset of rows to the requesting virtual space.

The memory 110 may additionally or alternatively comprise a portion of memory 110 (e.g., one or more memories or a portion of a single memory) that collectively forms a datastore 118 (e.g., a database). In some examples, the datastore 118 can be integrated with the server(s) 102, as shown in FIG. 1. In other examples, the datastore 118 can be located remotely from the server(s) 102 and can be accessible to the server(s) 102 and/or user device(s), such as the user computing device(s) 104. The datastore 118 can comprise multiple databases, which can include user/org data 120. Additional or alternative data may be stored in the data store and/or one or more other data stores.

In at least one example, the user/org data 120 can include permission data associated with permissions of individual users of the system or environment (e.g., sales-based platform, chat engine, search engine, etc.). In some examples, permissions can be set automatically or by an administrator of the platform, an employer, enterprise, organization, or other entity that utilizes the platform, a team leader, a group leader, or other entity that utilizes the platform for communicating with team members, group members, or the like, an individual user, or the like. Permissions associated with an individual user can be mapped to, or otherwise associated with, an account or profile within the user/org data 120. In some examples, such users can be defined by common access credentials, group identifiers, or the like, as described above.

In at least one example, the user/org data 120 can include data associated with one or more organizations of the platform. In at least one example, the user/org data 120 can store data in organization profiles, which can store data associated with an organization (or company), including, but not limited to, one or more user identifiers associated with the organization, one or more virtual space identifiers associated with the organization (e.g., workspace identifiers, communication channel identifiers, direct message instance identifiers, collaborative document identifiers, canvas identifiers, audio/video conversation identifiers, etc.), an organization identifier associated with the organization, one or more organization identifiers associated with other organizations that are authorized for communication with the organization, and the like.

It will be appreciated that the terms “datastore,” “database,” “repository,” and “network database” may be used interchangeably in areas of the present disclosure. As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like).

The memory 110 may additionally or alternatively store application programming interface(s) (API(s) 128), hypervisor(s), container orchestration system(s), an operating system, and/or container (unillustrated). The API(s) 128 may expose back-end functions and/or services hosted by the server(s) 102 to the user computing device(s) 104 and/or different component(s) hosted by the server(s)102 without transferring the functions/services/software to those computing device(s) and/or by accomplishing the functions and/or services at the server(s)102. As relates to the instant discussion, this may comprise API(s) for receiving indications from a user (e.g., as part of an API call), or from different ones of the components.

In some examples, software executed at the user computing device(s) 104, such as a client application 130, may generate API call(s) to the API(s) 128 and/or any of the component(s) discussed herein may transmit call(s) to the API(s) 128 and/or receive responses from the API(s) 128. For example, a user interface 132 executed by a client application 130 may display actuatable/selectable options to request that the client application 130 perform an action. In some examples, the client application 130 may interface with the API(s) 128 to authenticate a user and grant or deny the user access to a portion of the datastore 118 and/or data searching component 116.

The memory 110 may additionally or alternatively an operating system and/or container. In some examples, one or more containers may be instantiated by a cloud orchestrator and may run the operating system and may execute one or more instances of the API(s) 128 and the data searching component 116 and may permit access to a portion of the datastore 118 according to permissions associated with a user and an organization associated with the container.

In some examples, the server(s) 102 may further comprise communication interface(s) 134, which can include one or more interfaces and hardware components for enabling communication with various other devices (e.g., the user computing device(s) 104), such as over the network(s) 106 or directly. In some examples, the communication interface(s) 134 can facilitate communication via WebSockets, APIs (e.g., using API calls), Hypertext Transfer Protocols (HTTPs), etc. The server(s)102 can further be equipped with various input/output devices 136 (e.g., I/O devices). Such input/output devices 136 can include a display, various user interface controls (e.g., buttons, joystick, keyboard, mouse, touch screen, etc.), audio speakers, connection ports, and so forth.

In at least one example, the user computing device(s) 104 can include processor(s) 112, memory 114, communication interface(s) 122, and/or input/output device(s) 126. The memory 110 may store and execute a client application 130 and/or an operating system 124. In some examples, the client application 130 may be configured to authenticate a user to access data and/or services hosted by the server(s) 102. The API(s) 128 may filter the users and/or orgs accessible depending on permissions granted to a type of user profile and/or an organization associated with the user. In at least one example, a user profile to which a user authenticates can include permission data associated with permissions of individual users of the platform. In some examples, permissions can be set automatically or by an administrator of the platform, an employer, enterprise, organization, or other entity that utilizes the platform, a team leader, a group leader, or other entity that utilizes the platform for communicating with team members, group members, or the like, an individual user, or the like. Permissions associated with an individual user can be mapped to, or otherwise associated with, an account or profile. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the platform by maintaining security for limiting access to a defined group of users. In some examples, such users can be defined by common access credentials, group identifiers, or the like, as described above.

In some examples, the client application 130 may additionally or alternatively comprise instructions executable by one or more processors to provide a user interface 132. For example, the user interface 132 may comprise a graphical user interface (GUI), that the instructions may cause to be displayed via at least one of the input/output device(s) 126. In at least one example, the client application 130 can be a mobile application, a web application, a database interface (e.g., such as an application that presents a SQL or other database interface), or a desktop application. For example, a computing device of the one or more user computing device(s) 104 may access the API(s) 128 via a web browser or stand-alone application (either of which may be part of or host the client application 130) that communicates via network(s) 106 with API(s) 128.

In at least one example, the operating system 124 can manage the processor(s) 112, memory 114, hardware, software, etc. of the server(s) 102.

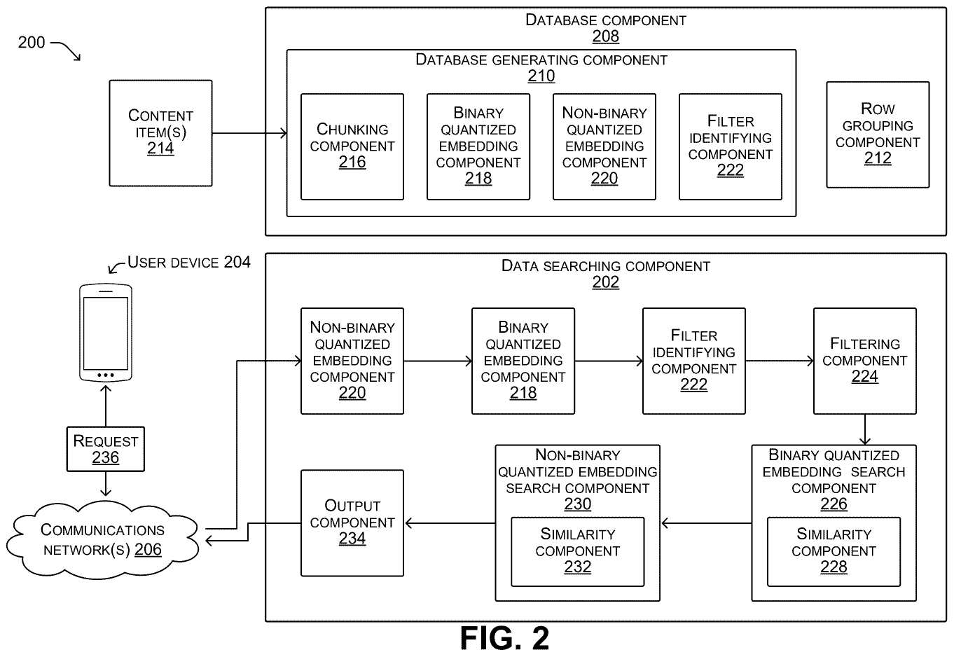

FIG. 2 depicts a block diagram 200 illustrating the interactions of components of a data searching component 202 configured to perform a vector search using multiple types of embeddings.

In some examples, the example block diagram 200 may be implemented with and/or in conjunction with a communication platform, search engine, sales-based platform, chatbot engine, and/or any other type of platform or system. As shown, the example block diagram 200 may include a database component 208 configured to generate searchable databases. In this example, the database component 208 may include a database generating component 210 and/or a row grouping component 212.

As shown, the database component 208 may receive content item(s) 214. As indicated above, the content item(s) 214 may include documents, audio, video, pictures, and/or any other type or medium of data. In some examples, the content item(s) 214 may be owned, organized, and/or associated with an organization, a company, a user, etc. Alternatively, the content item(s) 214 may be freely available data within or on the internet. As shown, the content item(s) 214 may be sent to the database generating component 210.

In this example, the database component 208 may include a database generating component 210 configured to generate a database. The database may include one or more rows and/or columns. In some examples, the rows may correspond to a chunk (or subset) of the content item. The columns may correspond to non-binary quantized embeddings, binary quantized embeddings, and/or filter(s). As shown, the database generating component 210 may include one or more subcomponents such as the chunking component 216, the binary quantized embedding component 218, the non-binary quantized embedding component 220, and/or the filter identifying component 222.

In some examples, the chunking component 216 may be configured to chunk the content item(s) 214. That is, the chunking component 216 may determine subset(s) of the content item(s) 214. A chunk or a subset of data may be a portion (e.g., less than all of the content item, less than an entirety of the content item, etc.) of the document, picture, file, audio, etc. For example, a chunk of data may be a paragraph within a document, one or more sentences within a document or paragraph, a verse in a song, etc. In some examples, the system may generate the chunks of data based on topic (e.g., chunk data such that the data within a chunk corresponds to a same topic), length (or size) of the content (e.g., number of sentences within a threshold limit), etc. As an example, a content item may be a document. In this example, the chunking component 216 may determine that each paragraph in the document is a chunk (or subset). Alternatively, the chunking component 216 may determine that a first portion of the document is a first chunk based on the first portion relating to a first topic while a second portion of the document is a second chunk based on the second portion relating to a second (and different) topic.

In some examples, the non-binary quantized embedding component 220 may be configured to generate a full length, float-based embedding based on the chunk. That is, the non-binary quantized embedding component 220 may include machine-learned model(s) that are trained to output embeddings that are representative of the chunk of data. In some examples, the non-binary quantized embedding may include one or more dimensions that include float values which are representative of features, attributes, and/or qualities of the chunk of data.

In some examples, the binary quantized embedding component 218 may be configured to generate a binary quantized embedding based on the non-binary quantized embedding as generated by the non-binary quantized embedding component 220. A binary quantized embedding may be a shortened representation of the full length embedding. The quantized embedding may include binary values (e.g., zero or one) rather than the float values included in the non-binary quantized embeddings. As indicated above, the binary quantized embedding component 218 may determine the binary quantized embedding by determining a threshold which may be based on a median of one or more model outputs. That is, the binary quantized embedding component 218 may identify content items that are similar (e.g., similar language, similar topic, similar author, etc.) and input such content items into the machine-learned model. The machine-learned model may output non-binary embeddings and the binary quantized embedding component 218 may determine a distribution of the float values within the non-binary quantized embeddings and identify the median value. In this example, the median value may be the threshold. As such, the binary quantized embedding component 218 may generate the binary quantized embedding by assigning the value in the binary quantized embedding a ‘0’ if the corresponding value in the non-binary quantized embedding is below the threshold and a ‘1’ if the corresponding value in the non-binary quantized embedding is above the threshold.

In some examples, the filter identifying component 222 may be configured to identify filter(s) within the chunk of data. That is, the filter identifying component 222 may analyze the chunk of data and/or the associated content item to determine filtering data such as authorship, recency data, topic data, etc.

Based on the data determined by the chunking component 216, the binary quantized embedding component 218, the non-binary quantized embedding component 220, and/or the filter identifying component 222, the database generating component 210 may generate a database that includes some or all types of the data. As noted above, the database generating component 210 may store the database in any type of platform and/or system.

In some examples, the row grouping component 212 may be configured to group rows of the database into subsets based on the filters. For example, the row grouping component 212 may group rows based on authorship first name letters. That is, the row grouping component 212 may determine first subset of rows in the database that correspond to authors with a first letter from “A-G,” the second subset of rows in the database that correspond to authors with the first letter from “H-T,” and the third subset of rows in the database that correspond to authors with the first letter from “U-Z.” Additionally or alternatively, the row grouping component 212 may group the rows according to any other type of filter such as publish date, organization names, etc. The row groupings may allow the data searching component 202 to bypass certain rows in the database based on leveraging the groupings. For example, if the data searching component 202 receives a query with a filter of “John Smith,” prior to comparing the filter data to the filters of the rows, the data searching component 202 may compare the filters to the rows groupings. That is, in this example, the data searching component 202 may determine to bypass comparing the filter data with the rows in the first and second subsets since “J” is within the second subset. Additionally or alternatively, the row grouping component 212 may determine a hierarchy (or ranking) of the row groupings. That is, the row grouping component 212 may associate ranking values to some or all groupings such that the data searching component 202 may prioritize which groupings to evaluate first and/or bypass. Further, in some cases, if a subset (e.g., less than all) of the row groupings can be evaluated, the data searching component 202 may prioritize the highest ranked (or the highest in hierarchy) row grouping(s).

In some examples, the example block diagram 200 may be implemented with and/or in conjunction with a communication platform, search engine, sales-based platform, chatbot engine, and/or any other type of platform or system. In this example, the example block diagram 200 may include one or more user devices 204 configured to communicate with a communication platform via a communication network 206. Additionally, the example block diagram 200 may include a data searching component 202 configured to perform vector searching and return an output to the user device 204.

In some examples, the data searching component 202 may include a binary quantized embedding component 218 configured to generate a binary quantized embedding based on the non-binary quantized embedding as generated by the non-binary quantized embedding component 220, a non-binary quantized embedding component 220 configured to generate a full length, float-based embedding based on the chunk, a filter identifying component 222 configured to determine or identify filters in the request, a filtering component 224 configured to determine subsets of rows based on filter data, a binary quantized embedding search component 226 configured to determine a subset of the most similar binary quantized embeddings in the database, a non-binary quantized embedding search component 230 configured to determine a subset of the most similar non-binary quantized embeddings in the database, and/or an output component 234 configured to output the data associated with the rows identified by the non-binary quantized embedding search component 230.

Importantly, in some cases, the data searching component 202 may perform the operations associated with each component when performing the vector search. However, in other examples, the data searching component 202 may perform a subset (e.g., less than all) of the operations associated with the component(s) included therein when performing the vector search. For instance, in some cases, the data searching component 202 may determine to bypass (or not perform) the operations associated with one or more of the filter identifying component 222, the filtering component 224, the binary quantized embedding search component 226, and/or the non-binary quantized embedding search component 230 while in other cases the data searching component 202 may perform the operations associated with each component. As an example, if the request 236 lacks filter data, the data searching component 202 may forego the operations associated with the filtering component 224. In other examples, if the number of the subset of rows determined by the filtering component 224 is below a threshold number (e.g., there are a limited number of rows), the data searching component 202 may bypass the operations of the binary quantized embedding search component 226 and directly perform the operations of the non-binary quantized embedding search component 230.

In some examples, the example block diagram 200 may include one or more user devices 204 configured to communicate with a data searching component 202. The example block diagram 200 includes a user device 204. In this example, the user device 204 may be a mobile phone; however, in other examples, the user device 204 may be any other type of mobile device (e.g., wearable, tablet, etc.), stationary device (e.g., laptop, desktop, etc.), and/or any other type of device. In this example, the user device 204 may communicate with the data searching component 202 via the communication network(s) 106, as described in FIG. 1. In some examples, a user may use the user device 204 to send a request 236 to a system that includes the data searching component 202. In such cases, the request 236 may include user data (e.g., user profile, username, user role, user organization/company, etc.) and/or the requested action for the system to perform. In this example, the request 236 may include instructions (e.g., a question, a command, data to rely on, etc.) for the system to perform a task that relies on an LLM. In such cases, the data searching component 202 may generate input data to input to the LLM.

In some examples, the data searching component 202 may include a non-binary quantized embedding component 220 configured to generate a full length, float-based embedding based on the request. That is, the non-binary quantized embedding component 220 may receive the request 236 from the user device 204. Further, based on receiving the request 236, the non-binary quantized embedding component 220 may generate a non-binary quantized embedding representative of the request 236 data. The operations may be similar or identical to the operations performed by the non-binary quantized embedding component 220 of the database component 208.

In some examples, the data searching component 202 may include a binary quantized embedding component 218 configured to generate a binary quantized embedding based on the non-binary quantized embedding as generated by the non-binary quantized embedding component 220. That is, the binary quantized embedding component 218 may generate a binary quantized embedding based on the non-binary quantized embedding described above. In some examples, the binary quantized embedding component 218 may perform similar or identical operations as the binary quantized embedding component 218 described in the database component 208.

In some examples, the data searching component 202 may include a filter identifying component 222 configured to determine or identify filters in the request. That is, the filter identifying component 222 may receive the request 236 and determine whether the request 236 includes any filters. In some examples, the filter identifying component 222 may use one or more heuristics and/or machine-learned models to identify the filters.

In some examples, the data searching component 202 may include a filtering component 224 configured to determine subsets of rows based on filter data. That is, the filtering component 224 may receive the filter(s) identified in the request 236 from the filter identifying component 222. Further, the filtering component 224 may compare the filter(s) from the request with the filter(s) in the database determined by the database component 208. In such examples, the filtering component 224 may identify a subset of rows in the database that have filter(s) that satisfy the request 236 filter(s). In such cases, the subset determined or otherwise identified by the filtering component 224 may be a first subset.

In some examples, the data searching component 202 may include a binary quantized embedding search component 226 configured to determine a subset of the most similar binary quantized embeddings in the database. In such cases, the binary quantized embedding search component 226 may determine similarity scores between the binary quantized embedding of the request and the binary quantized embeddings in the first subset of rows. The binary quantized embedding search component 226 may use the similarity scores to identify a threshold number of the most similar binary quantized embeddings and include the associated rows in a second subset. For example, the similarity component 228 may determine similarity scores based on distances between the request-based binary quantized embedding and the database-based binary quantized embeddings. Importantly, the similarity component 228 may determine the similarity scores for the binary quantized embeddings that correspond to a row within the first subset of rows.

In some examples, the data searching component 202 may include a non-binary quantized embedding search component 230 configured to determine a subset of the most similar non-binary quantized embeddings in the database. In such cases, the non-binary quantized embedding search component 230 may determine similarity scores between the non-binary quantized embedding of the request 236 and the non-binary quantized embeddings in the second subset of rows. The non-binary quantized embedding search component 230 may use the similarity scores to identify a threshold number of the most similar non-binary quantized embeddings and include the associated rows in a third subset. For example, the similarity component 232 may determine similarity scores based on distances between the request-based non-binary quantize embedding and the database-based non-binary quantize embeddings. Importantly, the similarity component 232 may determine the similarity scores for the non-binary quantize embeddings that correspond to a row within the second subset of rows. In some examples, the similarity component 232 may perform similar or identical operations as the similarity component 228.

In some examples, the data searching component 202 may include an output component 234 configured to output the data associated with the rows identified by the non-binary quantized embedding search component 230. As indicated above, the output component 234 may receive the third subset of rows from the non-binary quantized embedding search component 230 and cause the data associated with such rows to be output to the user device 204. In some cases, prior to outputting the data of the third subset of rows, the output component 234 may perform one or more actions requested by the user in the request 236. For example, the request 236 may instruct the system to summarize, synthesize, etc. the data being returned. As such, the output component 234 may receive the data (e.g., the chunk(s) of data) associated with the third subset of rows, perform the action of the data (e.g., summarize the data, synthesize the data, etc.), and output the modified data to the user device 204.

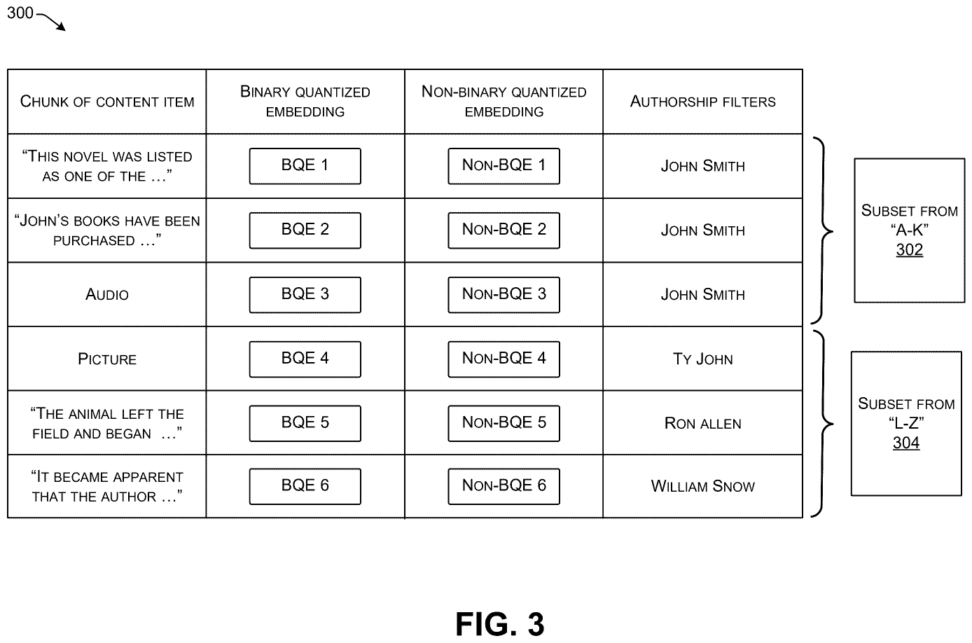

FIG. 3 is an example database 300 illustrating as a table including rows and/or columns that include non-binary quantized embedding(s), binary quantized embedding(s), filter(s), and/or subsets of content item(s).

In this example, the example database 300 may include multiple columns and multiple rows. The columns may include chunks of the content item, binary quantized embeddings, the non-binary quantized embeddings, and authorship filters. Of course, this is not intended to be limiting; in other examples, there may be more or fewer filter columns and/or the filter columns may be associated with the same or different types of data. In some examples, the rows may correspond to the data associated with a single chunk of data (or subset of data). For example, the second row may have a chunk of data that includes text data stating, “This novel was listed as one of the . . . .” In this case, the data on the second row may all correspond to the same chunk of data. That is, the binary quantized embedding on the second row may be a binary quantized embedding of the chunk of data on the second row, the non-binary quantized embedding on the second row may be a non-binary quantized embedding of the chunk of data on the second row, and the authorship filter may be a filter included in the chunk of data on the second row.

As shown, the first column may include chunks of the content items. As noted above, a content item may be a document, a picture, audio, a video, etc. A chunk of the content item may be a portion of the content item that is less than all of the content item (e.g., a paragraph of a document, a sentence of a paragraph, etc.). In this example, the chunks of the content item may include text, audio, and pictures. However, in other examples, the chunks of data may include more or fewer types of content items and the chunks may be larger or smaller.

In this example, non-binary quantized embedding column may include the non-binary quantized embeddings (e.g., the full length embeddings) representative of the chunk of data. As noted above, the system may determine non-quantized embeddings by inputting the chunk of data into a machine-learned model which may be trained to output full length, float-based embeddings of the chunk of data. As an example, the non-BQE 1 (e.g., the non-binary quantized embedding 1) may be a non-binary quantized embedding of the chunk of data stating, “This novel was listed as one of the . . . .”

In this example, the binary quantized embedding column may include the binary quantized embedding based on the non-binary quantized embedding. As noted above, the system may determine the binary quantized embedding based on comparing the float values in the non-binary quantized embedding to a threshold and assigning ‘0’ and ‘1’ values based on whether such values are above or below the threshold. As an example, the BQE 1 (e.g., binary quantized embedding 1) may be a binary quantized embedding of the Non-BQE 1.

In this example, the authorship filters may include authors of the corresponding chunk of data. That is, the chunk of data may include data (or metadata) that indicates the author of such data. In this case, the author may be a filter which may be stored in the database. For example, the second row may include “John Smith” as the author of three different chunks of data. As noted above, the vector searching component may use the filters when determining which rows of the database to search.

In this example, the example database 300 may include two groupings of the rows. As shown, the groupings may include a first subset 302 that includes three rows of the example database 300 and a second subset 304 that includes three rows of the example database 300. The first subset 302 may group rows together that have authors with names starting between the letters “A-K” and the second subset 304 may group rows together that have authors with names starting between the letters “L-Z.” The first and second subset may be used when the data searching component is performing a vector search in the example database 300. For example, if the received query includes a filter for an author's name “John Smith,” before comparing the filter (e.g., “John Smith” to each row within the example database 300, the system can determine which subset of rows “John Smith” is within based on the groupings of rows. That is, in this example, the system may determine that “John Smith” starts with the letter “J” and authors that have names that start with the letter “J” are included in the first subset 302. As such, the system may perform the filtering operation solely on the rows within the first subset 302 while excluding the rows in the second subset 304 from the operation. Grouping rows together may reduce the number of rows that are to be searched and/or filtered.

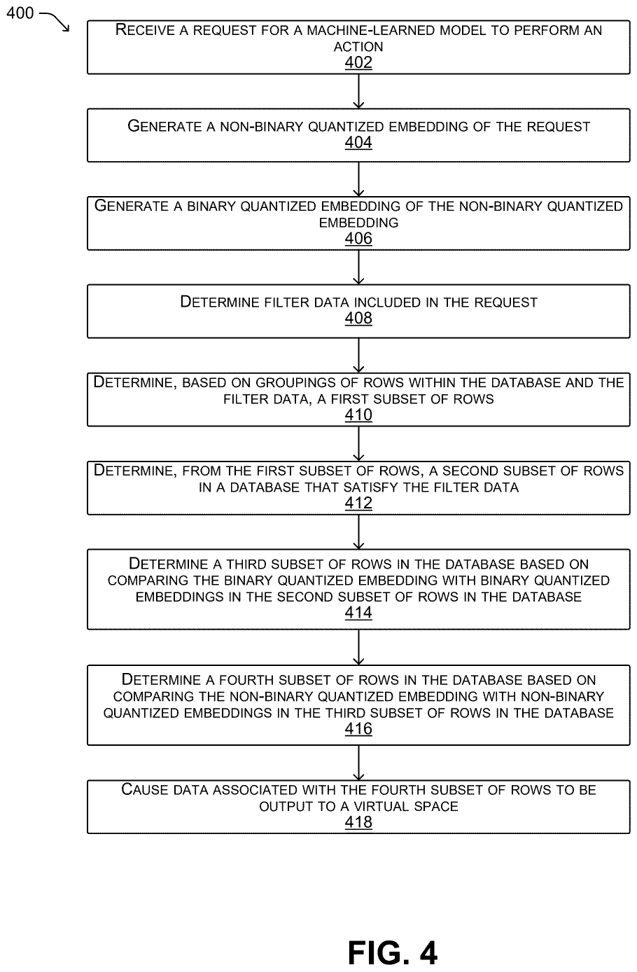

FIG. 4 is a flow diagram illustrating an example process 400 for receiving a query, determining non-binary quantized embedding based on the query, determining a binary quantized embedding based on the non-binary quantized embedding, determining a subset of rows of a database based on the binary quantized embedding, determining a second subset of rows based on the non-binary quantized embedding and the first subset, and outputting the second subset to a virtual space. The processes illustrated in FIG. 4 is described with reference to components described above with reference to the example environment 100 shown in FIG. 1 for convenience and ease of understanding. However, the processes illustrated in FIG. 4 is not limited to being performed using the components described above with reference to the example environment 100. Moreover, the components described above with reference to the example environment 100 are not limited to performing the processes illustrated in FIG. 4.

Process 400 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures or environments.

At operation 402, the process 400 can include receiving a request for a machine-learned model to perform an action. A query may be a question, comment, request, etc. That is, a user profile may submit a request (or query) to the system for the system to perform an action. The user profile may submit the request by verbally commanding (e.g., speaking-audio data) the system to perform an action, interacting with a user device that uses the system (e.g., clicking or touching a user interface object within the system, typing and/or submitting text to a text entry box within the system, etc.), etc. In some examples, the request may include an instruction for the system to perform an action. The actions may include summarizing data, synthesizing data, generating documents, responding to question(s) and/or prompt(s), receiving data, etc.

At operation 404, the process 400 can include generating a non-binary quantized embedding of the request. That is, the system may include one or more machine-learned models trained to generate full length embeddings of queries. In this example, the system may generate the full length query embedding by inputting the query into a machine-learned model which may output a full length query embedding. The full length query embedding may be a similar type of full length embedding to the full length embeddings described above. For instance, the query full length embedding may include large numbers of values which may be float values.

At operation 406, the process 400 can include generating a binary quantized embedding of the non-binary quantized embedding. That is, the system may generate a binary quantized query embedding such that the system may be able to perform vector searches on the database described above on the quantized embeddings stored therein. In some examples, the system may generate the quantized query embedding by performing similar or identical operations as those described above. For instance, the system may determine a threshold and use the threshold to determine binary values based on the float values of the full length query vector.

At operation 408, the process 400 can include determining filter data included in the request. As indicated above, the filter may be narrow the search and/or requested content desired by the requesting user. For example, the query may be “what is the most popular book written by John Smith?” In this example, the filter may be “John Smith,” since the requesting user is requesting results solely focused on “John Smith” and not other authors. Other filters the requesting user may include can include a time frame from which to search, other co-authors, etc.

At operation 410, the process 400 can include determining, based on groupings of rows within the database and the filter data, a first subset of rows within the database. For example, when generating the database, the system may group rows based on authorship first name letters. That is, the system may determine a first subset of rows in the database that correspond to authors with a first letter from “A-G,” the second subset of rows in the database that correspond to authors with the first letter from “H-T,” and the third subset of rows in the database that correspond to authors with the first letter from “U-Z.” Additionally or alternatively, the system may group the rows according to any other type of filter such as publish date, organization names, etc. The row groupings may allow the data searching component to bypass certain rows in the database based on leveraging the groupings.

For example, the system may leverage the row groupings when performing the vector search. For example, the system may compare the filter data to the rows groupings. In such cases, the system may identify a group of rows within which the filter data falls or satisfies. For example, if the filter is “John Smith,” the system may determine the that the second subset or grouping of rows satisfies the filter and as such, the second grouping of rows may be considered the “first subset” of rows used in operation 412.

At operation 412, the process 400 can include determining, from the first subset of rows, a second subset of rows in a database that satisfy the filter data. That is, the system may use the query filter data to reduce the number of rows that the system is to consider when performing the embedding comparisons. For example, the system may compare the query filter data to the database filter data and identify rows (or chunks of data) that satisfy the query filter data. In some cases, the system may analyze the filter data of each row within the first subset of rows in database.

At operation 414, the process 400 can include determining a third subset of rows in the database based on comparing the binary quantized embedding with binary quantized embeddings in the second subset of rows in the database. That is, the system may perform a comparison operation to identify, from the rows in the second subset, which database quantized embeddings are most similar to the query quantized embedding. In such examples, the system may compare the values of the query quantized embedding with the values of the database quantized embedding. The system may determine similarity scores that indicate the level to which a specific database quantized vector matches the query quantized vector. In some cases, the system may perform such a similarity comparison using one or more heuristics and/or one or more machine-learned models. Based on determining the similarity scores, the system may determine the second subset by including the rows with the database quantized embeddings that meet or exceed a threshold. The threshold may be used to filter out the rows with database quantized vectors with lower similarity scores. For example, the threshold may be 90 which may indicate that the third subset includes the 90 rows that have quantized vectors with the highest similarity scores.

At operation 416, the process 400 can include determining a fourth subset of rows in the database based on comparing the non-binary quantized embedding with non-binary quantized embeddings in the third subset of rows in the database. That is, the system may perform a comparison, from the rows included in the third subset (e.g., most similar quantized embeddings), operation to identify which database full length embeddings are most similar to the query full length embedding. In such examples, the system may compare the values of the query full length embedding with the values of the database full length embedding. The system may determine similarity scores that indicate the level to which a specific database full length vector matches the query full length vector. In some cases, the system may perform such a similarity comparison using one or more heuristics and/or one or more machine-learned models. Based on determining the similarity scores, the system may determine the third subset of rows by including the rows with the full length database embeddings that meet or exceed a threshold. The threshold may be used to filter out the rows with full length database vectors with lower similarity scores. For example, the threshold may be 5 or 10 which may indicate that the fourth subset includes the 5 or 10 rows that have full length vectors with the highest similarity scores. In some examples, the threshold for the full length vector comparison may be less than the threshold for the quantized vector comparison.

At operation 418, the process 400 can include causing data associated with the fourth subset of rows to be output to a virtual space. That is, the system may perform any requested action (e.g., summarized data, synthesize data, etc.) on the chunks of data included in the fourth subset and output the response. The system may output the output data via displaying the output data on a user interface of a user device and/or causing a device to emit the output data via audio. That is, if the user requested the action via a user interface of a user device, the system may cause the output data to be displayed via the user interface. Further, if the user requested the action via speaking to a device, the system may cause the output to be emitted via audio. However, this is not intended to be limiting; in other examples, the system may emit the output via audio in response to the user requesting the action via a user interface and/or the system may cause the output data to be displayed via user interface in response to the user verbally requesting the action.

### Example Clauses

A: A system comprising: one or more processors; and one or more non-transitory computer-readable media storing computer-executable instructions that, when executed, cause the one or more processors to perform operations comprising: receiving a request for a machine-learned model to perform an action; generating, in response to the request, a non-binary quantized embedding of the request; generating a binary quantized embedding of the non-binary quantized embedding; determining filter data included in the request; determining, based at least in part on accessing a database, a first subset of rows in the database that satisfy the filter data; determining, based at least in part on comparing the binary quantized embedding with one or more binary quantized embeddings in the first subset of rows in the database, a second subset of rows in the database; determining, based at least in part on comparing the non-binary quantized embedding with one or more non-binary quantized embeddings in the second subset of rows in the database, a third subset of rows in the database; and causing data associated with the third subset of rows to be output to a virtual space.

B: The system of paragraph A, wherein determining the second subset of rows comprises: identifying, based at least in part on accessing the database, a database binary quantized embedding associated with a row in the database; determining, based at least in part on comparing the binary quantized embedding with the database binary quantized embedding, a similarity score; and determining, based at least in part on the similarity score meeting or exceeding a threshold, to include the row in the first subset of rows.

C: The system of paragraph A, wherein determining the binary quantized embedding is based at least in part on: determining a binary value to be included in the binary quantized embedding based at least in part on a corresponding value in the non-binary quantized embedding being below a threshold.

D: The system of paragraph C, wherein the threshold is determined based at least in part on: receiving content items that are associated with request; inputting the content items into the machine-learned model; receiving, from the machine-learned model, multiple binary quantized embeddings; and determining, as the threshold, a median value associated with the multiple binary quantized embeddings.

E: The system of paragraph A, wherein the database is generated based at least in part on: receiving a content item; determining a fourth subset of the content item, wherein the fourth subset is less than an entirety of the content item; generating, based at least in part on the fourth subset, a second non-binary quantized embedding; generating, based at least in part on the non-binary quantized embedding, a second binary quantized embedding; identifying one or more filters within the content item; and generating the database to include a row that comprises the fourth subset, the non-binary quantized embedding, the binary quantized embedding, and the one or more filters.

F: The system of paragraph A, wherein determining the first subset of rows is based at least in part on: identifying a filter within the database, wherein the filter is different than the non-binary quantized embedding or the binary quantized embedding; and determining, based at least in part on comparing the filter with the filter data, that the filter satisfies the filter data.

G: One or more non-transitory computer-readable media storing instructions executable by one or more processors, wherein the instructions, when executed, cause the one or more processors to perform operations comprising: receiving a request for a machine-learned model to perform an action; generating, in response to the request, a non-binary quantized embedding of the request; generating a binary quantized embedding of the non-binary quantized embedding; determining, based at least in part on comparing the binary quantized embedding with one or more binary quantized embeddings in a database, a first subset of rows in the database; determining, based at least in part on comparing the non-binary quantized embedding with one or more non-binary quantized embeddings in the first subset of rows in the database, a second subset of rows in the database; and causing data associated with the second subset of rows to output to a virtual space.

H: The one or more non-transitory computer-readable media of paragraph G, wherein determining the first subset of rows is in response to: identifying filter data included in the request; and determining, based at least in part on accessing the database, a third subset of rows in the database that satisfy the filter data, wherein determining the first subset of rows is based at least in part on comparing the binary quantized embedding with the one or more binary quantized embeddings in the third subset of rows in the database.

I: The one or more non-transitory computer-readable media of paragraph H, wherein determining the third subset of rows is based at least in part on: determining a filter within the database, wherein the filter is different than the non-binary quantized embedding or the binary quantized embedding; and determining, based at least in part on comparing the filter with the filter data, that the filter satisfies the filter data.

J: The one or more non-transitory computer-readable media of paragraph G, wherein determining the first subset of rows comprises: identifying, based at least in part on accessing the database, a database binary quantized embedding associated with a row in the database; determining, based at least in part on comparing the binary quantized embedding with the database binary quantized embedding, a similarity score; and determining, based at least in part on the similarity score meeting or exceeding a threshold, to include the row in the first subset of rows.

K: The one or more non-transitory computer-readable media of paragraph G, wherein determining the binary quantized embedding is based at least in part on: determining a binary value to be included in the binary quantized embedding based at least in part on a corresponding value in the non-binary quantized embedding being below a threshold.

L: The one or more non-transitory computer-readable media of paragraph K, wherein the threshold is determined based at least in part on: receiving content items that are associated with request; inputting the content items into the machine-learned model; receiving, from the machine-learned model, multiple binary quantized embeddings; and determining, as the threshold, a median value associated with the multiple binary quantized embeddings.

M: The one or more non-transitory computer-readable media of paragraph G, wherein the database is generated based at least in part on: receiving a content item; determining a fourth subset of the content item, wherein the fourth subset is less than an entirety of the content item; generating, based at least in part on the fourth subset, a second non-binary quantized embedding; generating, based at least in part on the non-binary quantized embedding, a second binary quantized embedding; identifying one or more filters within the content item; and generating the database to include a row that comprises the fourth subset, the non-binary quantized embedding, the binary quantized embedding, and the one or more filters.

N: A method comprising: receiving a request for a machine-learned model to perform an action; generating, in response to the request, a non-binary quantized embedding of the request; generating a binary quantized embedding of the non-binary quantized embedding; determining, based at least in part on comparing the binary quantized embedding with one or more binary quantized embeddings in a database, a first subset of rows in the database; determining, based at least in part on comparing the non-binary quantized embedding with one or more non-binary quantized embeddings in the first subset of rows in the database, a second subset of rows in the database; and causing data associated with the second subset of rows to output to a virtual space.

O: The method of paragraph N, wherein the first subset of rows is in response to: determining filter data included in the request; and determining, based at least in part on accessing the database, a third subset of rows in the database that satisfy the filter data, wherein determining the first subset of rows is based at least in part on comparing the binary quantized embedding with the one or more binary quantized embeddings in the third subset of rows in the database.

P: The method of paragraph O, wherein determining the third subset of rows is based at least in part on: determining a filter within the database, wherein the filter is different than the non-binary quantized embedding or the binary quantized embedding; and determining, based at least in part on comparing the filter with the filter data, that the filter satisfies the filter data.

Q: The method of paragraph N, wherein determining the first subset of rows comprises: identifying, based at least in part on accessing the database, a database binary quantized embedding associated with a row in the database; determining, based at least in part on comparing the binary quantized embedding with the database binary quantized embedding, a similarity score; and determining, based at least in part on the similarity score meeting or exceeding a threshold, to include the row in the first subset of rows.

R: The method of paragraph N, wherein determining the binary quantized embedding is based at least in part on: determining a binary value to be included in the binary quantized embedding based at least in part on a corresponding value in the non-binary quantized embedding being below a threshold.

S: The method of paragraph R, wherein the threshold is determined based at least in part on: receiving content items that are associated with request; inputting the content items into the machine-learned model; receiving, from the machine-learned model, multiple binary quantized embeddings; and determining, as the threshold, a median value associated with the multiple binary quantized embeddings.

T: The method of paragraph N, wherein the database is generated based at least in part on: receiving a content item; determining a fourth subset of the content item, wherein the fourth subset is less than an entirety of the content item; generating, based at least in part on the fourth subset, a second non-binary quantized embedding; generating, based at least in part on the non-binary quantized embedding, a second binary quantized embedding; identifying one or more filters within the content item; and generating the database to include a row that comprises the fourth subset, the non-binary quantized embedding, the binary quantized embedding, and the one or more filters.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A system comprising:
one or more processors; and
one or more non-transitory computer-readable media storing computer-executable instructions that, when executed, cause the one or more processors to perform operations comprising:
receiving a request for a machine-learned model to perform an action;
generating, in response to the request, a non-binary quantized embedding of the request;
generating a binary quantized embedding of the non-binary quantized embedding;
determining filter data included in the request;
determining, based at least in part on accessing a database, a first subset of rows in the database that satisfy the filter data;
determining, based at least in part on comparing the binary quantized embedding with one or more binary quantized embeddings in the first subset of rows in the database, a second subset of rows in the database;
determining, based at least in part on comparing the non-binary quantized embedding with one or more non-binary quantized embeddings in the second subset of rows in the database, a third subset of rows in the database; and
causing data associated with the third subset of rows to be output to a virtual space.

2. The system of claim 1, wherein determining the second subset of rows comprises:
identifying, based at least in part on accessing the database, a database binary quantized embedding associated with a row in the database;
determining, based at least in part on comparing the binary quantized embedding with the database binary quantized embedding, a similarity score; and
determining, based at least in part on the similarity score meeting or exceeding a threshold, to include the row in the first subset of rows.

3. The system of claim 1, wherein determining the binary quantized embedding is based at least in part on:
determining a binary value to be included in the binary quantized embedding based at least in part on a corresponding value in the non-binary quantized embedding being below a threshold.

4. The system of claim 3, wherein the threshold is determined based at least in part on:
receiving content items that are associated with request;
inputting the content items into the machine-learned model;
receiving, from the machine-learned model, multiple binary quantized embeddings; and
determining, as the threshold, a median value associated with the multiple binary quantized embeddings.

5. The system of claim 1, wherein the database is generated based at least in part on:
receiving a content item;
determining a fourth subset of the content item, wherein the fourth subset is less than an entirety of the content item;
generating, based at least in part on the fourth subset, a second non-binary quantized embedding;
generating, based at least in part on the non-binary quantized embedding, a second binary quantized embedding;
identifying one or more filters within the content item; and
generating the database to include a row that comprises the fourth subset, the non-binary quantized embedding, the binary quantized embedding, and the one or more filters.

6. The system of claim 1, wherein determining the first subset of rows is based at least in part on:
identifying a filter within the database, wherein the filter is different than the non-binary quantized embedding or the binary quantized embedding; and
determining, based at least in part on comparing the filter with the filter data, that the filter satisfies the filter data.

7. One or more non transitory computer readable media storing instructions executable by one or more processors, wherein the instructions, when executed, cause the one or more processors to perform operations comprising:
receiving a request for a machine-learned model to perform an action;
generating, in response to the request, a non-binary quantized embedding of the request;
generating a binary quantized embedding of the non-binary quantized embedding;
determining, based at least in part on comparing the binary quantized embedding with one or more binary quantized embeddings in a database, a first subset of rows in the database;
determining, based at least in part on comparing the non-binary quantized embedding with one or more non-binary quantized embeddings in the first subset of rows in the database, a second subset of rows in the database; and
causing data associated with the second subset of rows to output to a virtual space.

8. The one or more non transitory computer readable media of claim 7, wherein determining the first subset of rows is in response to:
identifying filter data included in the request; and
determining, based at least in part on accessing the database, a third subset of rows in the database that satisfy the filter data, wherein determining the first subset of rows is based at least in part on comparing the binary quantized embedding with the one or more binary quantized embeddings in the third subset of rows in the database.

9. The one or more non transitory computer readable media of claim 8, wherein determining the third subset of rows is based at least in part on:
determining a filter within the database, wherein the filter is different than the non-binary quantized embedding or the binary quantized embedding; and
determining, based at least in part on comparing the filter with the filter data, that the filter satisfies the filter data.

10. The one or more non transitory computer readable media of claim 7, wherein determining the first subset of rows comprises:
identifying, based at least in part on accessing the database, a database binary quantized embedding associated with a row in the database;
determining, based at least in part on comparing the binary quantized embedding with the database binary quantized embedding, a similarity score; and
determining, based at least in part on the similarity score meeting or exceeding a threshold, to include the row in the first subset of rows.

11. The one or more non transitory computer readable media of claim 7, wherein determining the binary quantized embedding is based at least in part on:
determining a binary value to be included in the binary quantized embedding based at least in part on a corresponding value in the non-binary quantized embedding being below a threshold.

12. The one or more non transitory computer readable media of claim 11, wherein the threshold is determined based at least in part on:
receiving content items that are associated with request;
inputting the content items into the machine-learned model;
receiving, from the machine-learned model, multiple binary quantized embeddings; and
determining, as the threshold, a median value associated with the multiple binary quantized embeddings.

13. The one or more non transitory computer readable media of claim 7, wherein the database is generated based at least in part on:
receiving a content item;
determining a fourth subset of the content item, wherein the fourth subset is less than an entirety of the content item;
generating, based at least in part on the fourth subset, a second non-binary quantized embedding;
generating, based at least in part on the non-binary quantized embedding, a second binary quantized embedding;
identifying one or more filters within the content item; and
generating the database to include a row that comprises the fourth subset, the non-binary quantized embedding, the binary quantized embedding, and the one or more filters.

14. A method comprising:
receiving a request for a machine-learned model to perform an action;
generating, in response to the request, a non-binary quantized embedding of the request;
generating a binary quantized embedding of the non-binary quantized embedding;
determining, based at least in part on comparing the binary quantized embedding with one or more binary quantized embeddings in a database, a first subset of rows in the database;
determining, in response to comparing the non-binary quantized embedding with one or more non-binary quantized embeddings in the first subset of rows in the database, a second subset of rows in the database; and
causing data associated with the second subset of rows to output to a virtual space.

15. The method of claim 14, wherein the first subset of rows is in response to:
determining filter data included in the request; and
determining, based at least in part on accessing the database, a third subset of rows in the database that satisfy the filter data, wherein determining the first subset of rows is based at least in part on comparing the binary quantized embedding with the one or more binary quantized embeddings in the third subset of rows in the database.

16. The method of claim 15, wherein determining the third subset of rows is based at least in part on:
determining a filter within the database, wherein the filter is different than the non-binary quantized embedding or the binary quantized embedding; and
determining, based at least in part on comparing the filter with the filter data, that the filter satisfies the filter data.

17. The method of claim 14, wherein determining the first subset of rows comprises:
identifying, based at least in part on accessing the database, a database binary quantized embedding associated with a row in the database;
determining, based at least in part on comparing the binary quantized embedding with the database binary quantized embedding, a similarity score; and
determining, based at least in part on the similarity score meeting or exceeding a threshold, to include the row in the first subset of rows.

18. (canceled)

19. The method of claim 14, wherein determining the binary quantized embedding is based at least in part on:
determining a binary value to be included in the binary quantized embedding based at least in part on a corresponding value in the non-binary quantized embedding being below a threshold, wherein the threshold is determined based at least in part on:
receiving content items that are associated with request;
inputting the content items into the machine-learned model;
receiving, from the machine-learned model, multiple binary quantized embeddings; and
determining, as the threshold, a median value associated with the multiple binary quantized embeddings.

20. The method of claim 14, wherein the database is generated based at least in part on:
receiving a content item;
determining a fourth subset of the content item, wherein the fourth subset is less than an entirety of the content item;
generating, based at least in part on the fourth subset, a second non-binary quantized embedding;
generating, based at least in part on the non-binary quantized embedding, a second binary quantized embedding;
identifying one or more filters within the content item; and
generating the database to include a row that comprises the fourth subset, the non-binary quantized embedding, the binary quantized embedding, and the one or more filters.

21. The system of claim 1, wherein the filter data is non-embedding data.
